(19) United States
(12) Patent Application Publication
(10) Pub. No.: US 2016/0013552 A1
(43) Pub. Date: Jan. 14, 2016

(54) Operating an Antenna Device of a User Equipment

(71) Applicant: Sony Corporation, Tokyo (JP)

(72) Inventors: Erik Bengtsson, Eslöv (SE); Ying Zhinong, Lund (SE)

(21) Appl. No.: 14/328,768

(22) Filed: Jul. 11, 2014

(51) Int. Cl. H01Q 3/34

(52) U.S. Cl. CPC H01Q 3/34

(57) ABSTRACT

The present invention relates to a method for operating an antenna device of a user equipment, a method for finding a base station or an access point of a wireless communication network with a user equipment, and a user equipment for a wireless communication network.

### FIELD OF THE INVENTION

The present invention relates to a method for operating an antenna device of a user equipment, especially to methods for finding a base station or an access point of a wireless communication network with a user equipment, for example for establishing a communication connection between the user equipment and the wireless communication network. The present invention relates furthermore especially to operating an antenna device of a user equipment providing a configurable transmission pattern.

### BACKGROUND OF THE INVENTION

The use of higher frequency bands for mobile communication is investigated due to the potential larger bandwidth availability. Such higher frequency bands are also called millimeter waves and may have a frequency of 10 GHz up to about hundreds of GHz. One issue that arises with these higher frequency bands is the fact that the wavelength is very small, and in order to achieve decent performance, multiple antennas, e.g. in the shape of an array, may be needed in the user equipment, for example a mobile telephone. Using such an antenna arrangement may offer a high antenna gain with a correct phasing of the antennas. However, correct phasing of the antennas is also a challenge. For a large number of antennas, the phasing narrows the antenna radiation into a beam and this beam needs to be directed towards the base station. Therefore, an iterative algorithm may be used for aligning the antenna arrangements at the base station and the user equipment. For example, the antenna arrangement at the base station and the antenna arrangement at the user equipment may scan for each other until a link can be established. Obviously, mobility of the user equipment may cause problems with such algorithms. Therefore, there is a need for an improved configuration of the antenna arrangement at the user equipment to set up a communication link to a base station or an access point of the wireless communication network.

### SUMMARY OF THE INVENTION

According to an embodiment of the present invention, a method for operating an antenna device of a user equipment is provided. The antenna device provides a configurable transmission pattern. For example, the antenna device comprises an antenna array or any other arrangement of a plurality of antennas and a direction of a high reception sensitivity may be configurable. According to the method, an orientation of the user equipment is determined with an orientation determining sensor of the user equipment. The orientation determining sensor may comprise for example a gyrometer, a gravity sensor or a compass. The transmission pattern of the antenna device is configured based on the determined orientation. Especially, an orientation of the user equipment with respect to a geological horizon may be determined and the transmission pattern of the antenna device is configured based on the determined orientation of the user equipment with respect to the geological horizon. Therefore, the orientation determining sensor in the user equipment is used to prioritize antenna arrangement beams steering in the horizontal plane for an arbitrary user equipment orientation. As a base station or an access point is usually located along the horizontal plane, i.e. the horizon, a likelihood for finding the base station or the access point may be increased by configuring the transmission pattern of the antenna device accordingly. Additionally, if the user equipment looses contact to the base station, based on the determined orientation the user equipment may use the same elevation as before to re-establish the contact to the base station. In this context, the term “base station” may comprise any kind of base stations, e.g. base stations of a cellular mobile communication network, access points of a wireless local area network, or any other hub. In a device-to-device communication, the “base station” may also relate to another user equipment, as in a device-to-device communication also other user equipments may be contacted preferably in the horizontal plane. Furthermore, as user equipments, like e.g. mobile phones, usually comprise sensors for determining an orientation of the user equipment, for example a sensor for detecting what is up and down, the orientation of the user equipment may be determined at low additional cost.

In this description, the term “transmission pattern” relates to a configuration of an antenna or an antenna arrangement determining a reception sensitivity in a certain direction and/or a sending characteristic in a certain direction or both. Therefore, the term “transmission” may relate to receiving signals, to sending signals or to both.

According to an embodiment, the transmission pattern of the antenna device is configured such that the transmission pattern is levelled along the geological horizon. Especially for frequencies below about 30 GHz the number of antenna elements is expected to be in a lower range, for example in a range of 4 to 16 antennas, and possibly in a one dimensional arrangement. In this case it is possible to configure the transmission pattern and thus the coverage of the antenna device along the horizon. For example, the transmission pattern of a single antenna or the antenna arrangement may be in the form of a disk, a so called donut, or at least a part of such a disk, and the axis of the disk may be levelled by configuring the antenna arrangement such that it is perpendicular to the horizon providing a high sensitivity and radiation of the antenna along the horizon. Levelling the transmission pattern along the horizon as it is used in this description includes a levelling approximately to the horizon, e.g. in an angle of up to +/−20 to 30 degrees with respect to a horizontal direction.

According to another embodiment, the transmission pattern of the antenna device is configured such that an antenna beam scan is performed along the geological horizon. At higher frequencies, for example at frequencies above 30 GHz, the number of antenna elements is expected to be higher, for example much higher than 10. Consequently, the directivity of the antenna arrangement will increase. Therefore, the determined orientation of the user equipment is utilized to initially scan the horizontal plane or at least prioritize it, to find a base station or an access point. This may decrease the log in time for the user equipment when a communication link is set up between the user equipment and a wireless communication network, thus improving the power efficiency of the user equipment and increasing reliability and availability, for example during a cell change.

According to another embodiment, a method for finding a base station or an access point of a wireless communication network with a user equipment is provided. The user equipment comprises an antenna device providing a configurable transmission pattern. The term “configurable transmission pattern” is used to indicate the ability of the antenna device to change a direction of a highest reception sensitivity or a direction of a highest radiation due to a configuration. For example, in case the antenna device comprises a plurality of antenna elements arranged in a one dimensional arrangement, an at least partially disk shaped transmission pattern is provided whose orientation may be changed due to the configuration. Furthermore, in case the antenna elements are arranged in a two dimensional arrangement, a pencil beam shaped transmission pattern may be provided whose direction may be changed due to the configuration. According to the method, an orientation of the user equipment with respect to a geological horizon is determined with an orientation determining sensor of the user equipment. Based on the determined orientation, the transmission pattern of the antenna device of the user equipment is levelled along the geological horizon. Therefore, a likelihood of finding the base station or the access point may be increased.

According to a further embodiment, a method for finding a base station or an access point of a wireless communication network is provided. The method may be performed by a user equipment comprising a plurality of antenna elements arranged in a two dimensional arrangement providing a configurable pencil beam shaped transmission pattern. According to the method, an orientation of the user equipment is determined with respect to a geological horizon with an orientation determining sensor of the user equipment. An environment of the user equipment is scanned with the pencil beam shaped transmission pattern in various directions for finding the base station or the access point, respectively. Based on the determined orientation of the user equipment, a direction of the geological horizon is scanned with a higher priority than other directions.

According to yet another embodiment, a user equipment for a wireless communication network is provided. The user equipment comprises an antenna device for receiving and sending radio frequency signals from and to a base station or an access point of the wireless communication network. The antenna device provides a configurable transmission pattern. For example, a direction of a highest sensitivity of the antenna device may be configurable. The user equipment comprises furthermore an orientation determining sensor for determining an orientation of the user equipment. Especially, the orientation determining sensor may provide an information concerning the orientation of the user equipment with respect to a horizon or the direction of gravity. Therefore, in case the user equipment is moved by a user, for example when the user equipment is rotated by the user, a current orientation of the user equipment may be determined by the orientation determining sensor. The user equipment comprises furthermore a processing device configured to configure the transmission pattern of the antenna device based on the determined orientation. Therefore, the transmission pattern of the antenna device may be aligned or levelled such that a high sensitivity or radiation of the antenna device along the horizon may be provided. As a base station or an access point is usually arranged along the horizon, setting up a communication link between the user equipment and a base station or an access point may be facilitated.

According to an embodiment, the user equipment comprises for example a mobile telephone, a mobile computer, a personal digital assistant, a tablet computer, a television set, a monitor, or a projector. E.g., a projector may know from sensors or configuration if it is installed at a ceiling, wall or on a desk and the transmission pattern may be configured based on this information.

Although specific features described in the above summary and the following detailed description are described in connection with specific embodiments and aspects of the present invention, it should be understood that the features of the exemplary embodiments and aspects may be combined with each other unless specifically noted otherwise.

### BRIEF DESCRIPTION OF THE DRAWINGS

The present invention will now be described in more detail with reference to the accompanying drawings.

FIG. 1 shows schematically a user equipment according to an embodiment of the present invention.

FIG. 2 shows a transmission pattern of a single dipole antenna.

FIG. 3 shows a transmission pattern of a row antenna.

FIG. 4 shows a transmission pattern of a two dimensional antenna arrangement.

FIG. 5 shows a flowchart comprising method steps of a method for operating an antenna device of a user equipment according to an embodiment of the present invention.

### DESCRIPTION OF PREFERRED EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or an indirect coupling unless specifically noted otherwise.

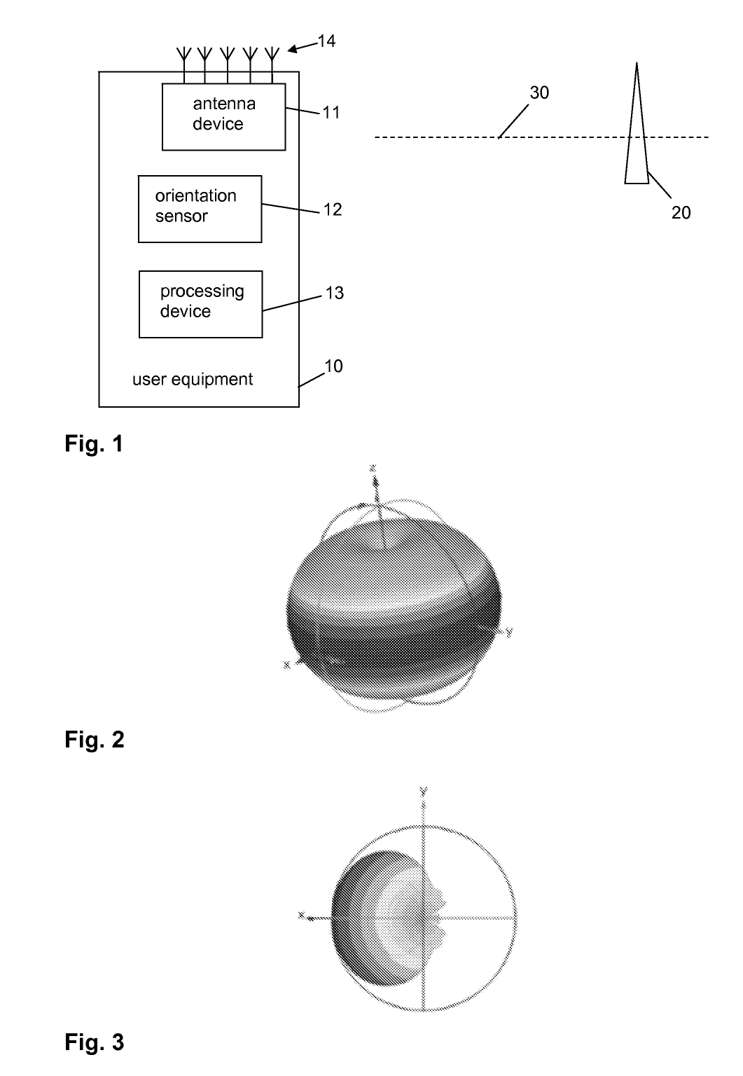

FIG. 1 shows a user equipment 10 arranged in an environment of a base station 20. The user equipment 10 may comprise for example a mobile telephone, especially for example a so called smartphone. The user equipment 10 comprises an antenna device 11, an orientation sensor 12 and a processing device 13. The antenna device 11 comprises a plurality of antennas or antenna elements 14. The base station 20 may be a base station of a cellular wireless communication network. A communication between the user equipment 10 and the base station 20 may be accomplished via a radio frequency communication in a frequency band of 10 GHz up to hundreds of GHz, called millimeter wave band. Due to the small wavelength and in order to achieve an appropriate performance, multiple antennas in the shape of an arrangement may be needed in the user equipment. With a correct configuration of the antennas, especially with a correct phasing of the antennas, a high antenna gain may be achieved. However, this configuration may narrow the antennas' radiation and reception pattern, for example into a beam. This beam needs to be directed towards the base station. Typical sending and reception patterns of different antenna arrangements will be described in the following in connection with FIGS. 2 to 4.

FIG. 2 shows a transmission pattern of a single dipole antenna. As can be seen from FIG. 2, an isotropic pattern around an antenna axis is obtained, which has the shape of a disc or donut having its axis arranged in the Z-direction as indicated in FIG. 2. When the antenna is placed with its top up, that means that the antenna is arranged perpendicular to a geological horizon, there is a high reception sensitivity and a high radiation along the antenna axis and a good reception or coverage along the horizon.

A transmission pattern of a one dimensional antenna arrangement is shown in FIG. 3. The transmission pattern may be a disk or donut like pattern or a segment of a disk or donut like pattern for a typical row antenna. Depending on the configuration of the antenna arrangement an orientation of the disk shaped pattern may be changed as required. It is to be noticed that a one dimensional arrangement may have only one degree of freedom for levelling the transmission pattern. For example, it may be possible only to level the transmission pattern in one direction, e.g. along the X-Y plane, and if the user equipment is tilted in the X-Z plane there is nothing to level with a one dimensional array having the X direction as the axis. However, if the user equipment is tilted in the X-Y plane, this may be compensated by a corresponding levelling.

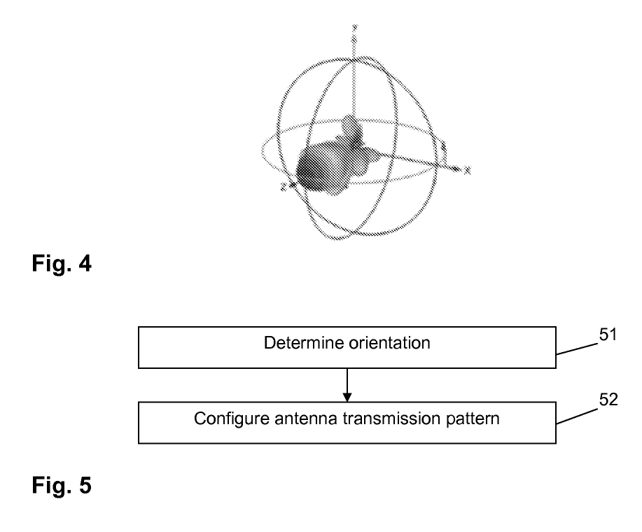

FIG. 4 shows a pencil beam pattern of a two dimensional antenna arrangement, e.g. a plurality of antennas may be arranged in an array of rows and columns. The direction of the pencil beam depends on the configuration of the antenna arrangement.

In a typical environment of the user equipment 10 and the base station 20, the base station 20 is located along a horizontal plane 30 with respect to the user equipment 10. In other words, usually the base station 20 is arranged along a geographical horizon. As shown in FIG. 1, the user equipment 10 comprises the orientation sensor 12 which may comprise for example a gyrometer, a gravity sensor or a compass. The orientation sensor 12 may be configured to determine an orientation of the user equipment 10 with respect to the geographical horizon or horizontal plane 30. User equipments, like for example mobile telephones, tablet computers and so on, usually comprise such orientation sensors, for example for aligning image outputs or for gaming applications. The processing device 13 utilizes information from the orientation sensor 12 for configuring the antenna device 11.

For example, as shown in FIG. 5, in step 51 the processing device 13 may determine a current orientation of the user equipment 10, and a transmission pattern of the antenna device 11 is configured depending on the determined orientation in step 52. In particular, the processing device 13 may use the orientation sensor 12 to adaptively level the antenna transmission pattern along the horizon 30. Therefore, the antenna device can be tuned to cover the horizontal plane 30 and the base station 20 may be found and contacted reliably.

In particular for antenna arrangements at frequencies below for example 30 GHz, the number of antenna elements may be in a lower range of 4 to 16 and may be arranged in a one dimensional arrangement. The disk shaped pattern or segment of a disk as shown in FIG. 3 may be achieved by the one dimensional antenna arrangement. Depending on the information from the orientation sensor 12 the processing device 13 optimizes the coverage of the one dimensional antenna arrangement along the horizon 30.

For antenna arrangements at frequencies above for example 30 GHz, the number of antenna elements may be larger, for example much larger than 10 or 20 and may be arranged in a two dimensional arrangement having a pencil beam shaped transmission pattern as shown in FIG. 4. Consequently, the directivity will increase. In this case, an algorithm may be utilized that initially scans the horizontal plane 30 or at least prioritizes the horizontal plane 30. Hence, a time for finding the base station 20 may be shortened thus improving operation reliability and power efficiency.

1. A method for operating an antenna device of a user equipment, wherein the antenna device provides a configurable transmission pattern, the method comprising:
determining an orientation of the user equipment with an orientation determining sensor of the user equipment,
configuring the transmission pattern of the antenna device based on the determined orientation.

2. The method according to claim 1, wherein determining the orientation comprises determining the orientation of the user equipment with respect to a geological horizon.

3. The method according to claim 2, wherein configuring the transmission pattern of the antenna device comprises leveling the transmission pattern along the geological horizon.

4. The method according to claim 2, wherein configuring the transmission pattern of the antenna device comprises performing an antenna beam scan along the geological horizon.

5. The method according to claim 1, wherein the orientation determining sensor comprises at least one of a group comprising a gyrometer, a gravity sensor, and a compass.

6. The method according to claim 2, wherein the antenna device comprises a plurality of antenna elements arranged in a one-dimensional arrangement providing an at least partially disc shaped transmission pattern, wherein configuring the transmission pattern of the antenna device comprises aligning the at least partially disc shaped transmission pattern with the geological horizon.

7. The method according to claim 2, wherein the antenna device comprises a plurality of antenna elements arranged in a two-dimensional arrangement providing a pencil beam shaped transmission pattern, wherein configuring the transmission pattern of the antenna device comprises scanning the geological horizon with the pencil beam shaped transmission pattern.

8. A method for finding a base station or an access point of a wireless communication network with a user equipment, wherein the user equipment comprises an antenna device providing a configurable transmission pattern, the method comprising:
determining an orientation of the user equipment with respect to a geological horizon with an orientation determining sensor of the user equipment, and
leveling the transmission pattern of the antenna device of the user equipment along the geological horizon.

9. A method for finding a base station or an access point of a wireless communication network with a user equipment, wherein the user equipment comprises a plurality of antenna elements arranged in a two-dimensional arrangement providing a configurable pencil beam shaped transmission pattern, the method comprising:
determining an orientation of the user equipment with respect to a geological horizon with an orientation determining sensor of the user equipment, and
scanning an environment of the user equipment with the pencil beam shaped transmission pattern in various directions for finding the base station or the access point, respectively, wherein scanning in a direction of the geological horizon has a higher priority than scanning in other directions.

10. A user equipment for a wireless communication network, comprising:
an antenna device for receiving radio frequency signals from a base station or an access point of the wireless communication network, wherein the antenna device provides a configurable transmission pattern,
an orientation determining sensor for determining an orientation of the user equipment, and
a processing device configured to configure the transmission pattern of the antenna device based on the determined orientation.

11. The user equipment according to claim 10, wherein the user equipment comprises at least one of a group consisting of a mobile telephone, a mobile computer, a personal digital assistant, a tablet computer, a television set, a monitor, and a projector.
